(19) United States
(12) Patent Application Publication
(10) Pub. No.: US 2009/0077081 A1
(43) Pub. Date: Mar. 19, 2009

(54) Attribute-Based Item Similarity Using Collaborative Filtering Techniques

(76) Inventors: Joydeep Sen Sarma, Sunnyvale, CA (US); Chao Wang, Columbus, OH (US); Anand Bhaskar, Pune (IN)

Correspondence Address: STATTLER - SUH PC, 60 SOUTH MARKET STREET, SUITE 480, SAN JOSE, CA, 95113, US

(21) Appl. No.: 11/857,847

(22) Filed: Sep. 19, 2007

(51) Int. Cl. G06F 7/00

(52) U.S. Cl. 707/8; 707/E17.044

(57) ABSTRACT

A system and method to compute attribute-based similarity between items using collaborative filtering techniques are described. Events input by a user over a network are received, the events further including a plurality of items and associated item metadata. A similarity value is further computed between each pair of items within the plurality of stems based on corresponding attributes of each item stored within the item metadata. Finally, recommendations of the items to the user are presented based on the corresponding calculated similarity value.

### TECHNICAL FIELD

The present invention relates generally to computer applications and, more particularly, to a system and method to compute attribute-based similarity between items using collaborative filtering techniques.

### BACKGROUND OF THE INVENTION

The explosive growth of the internet as a publication and interactive communication platform has created an electronic environment that is changing the way business is transacted. As the internet becomes increasingly accessible around the world, users need efficient tools to navigate the Internet and to find content available on various websites.

Internet portals provide users an entrance and a guide into the vast resources of the Internet. Typically, an Internet portal provides a range of search, email, news, shopping, chat, maps, finance, entertainment, and other content and services. Thus, the information presented to the users needs to be relevant to the users' activities and interests and must be efficiently and properly categorized and stored within the portal.

Therefore, what is needed is a system and method to identify similar items or products based on users' activities and interests and to recommend such similar items or products to the users.

### SUMMARY OF THE INVENTION

A system and method to compute attribute-based similarity between items using collaborative filtering techniques are described. Events input by a user over a network are received, the events further including a plurality of items and associated item metadata. A similarity value is further computed between each pair of items within the plurality of items based on corresponding attributes of each item stored within the item metadata. Finally, recommendations of the items to the user are presented based on the corresponding calculated similarity value.

Other features and advantages of the present invention will be apparent from the accompanying drawings and from the detailed description, which follow below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a processing sequence to determine similarity between items associated with input data received from users over a network and to facilitate recommendations of such similar items to users, according to one embodiment of the invention;

FIG. 2 is a block diagram illustrating an exemplary network-based entity containing a system to compute attribute-based similarity between items using collaborative filtering techniques, according to one embodiment of the invention;

FIG. 3 is a block diagram illustrating an exemplary database, which at least partially implements and supports the system and the network-based entity, according to one embodiment of the invention;

FIG. 4 is a flow diagram illustrating a method to receive and store input data over the network, according to one embodiment of the invention;

FIG. 5 is a flow diagram illustrating a method to process the input data to determine similarity between items associated with the input data, according to one embodiment of the invention;

FIG. 6 is a flow diagram illustrating a method to compute attribute distance parameters, according to one embodiment of the invention;

FIG. 7 is a flow diagram illustrating a method to compute item distance parameters between items associated with the input data based on corresponding attribute distance parameters, according to one embodiment of the invention;

FIG. 8 is a diagrammatic representation of a machine in the exemplary form of a computer system within which a set of instructions may be executed.

### DETAILED DESCRIPTION

Recommender systems apply data analysis techniques to determine and provide personalized recommendations of items, such as products and services, to users. Such recommender systems may be based on one or more known recommendation algorithms, such as, for example, Collaborative Filtering (CF) algorithms and/or Content-based Recommendation (CB) algorithms.

CF algorithms provide item recommendations or predictions to users based on opinions, preferences, and/or interests of other like-minded users, which can be obtained explicitly from a large number of users through ratings or other user input, or through implicit measures, such as derivations from event clicks, purchase patterns, and/or timing logs. CB algorithms provide item recommendations to users based on analyses of user-item links to identify relationships between different items and, subsequently, to compute the item recommendations.

However, several challenges have been identified in the application of the CF algorithms and the CB algorithms. One challenge relates to the sparsity of data in cases where the system is in its initial stages of use or coverage in terms of purchases, ratings feedback, or event clicks is insufficient. Another challenge surfaces when the item set is very dynamic, such as, for example, a set of news articles published on a website, and not enough data can be gathered for subsequent processing.

Therefore, the system described in detail below exploits the fact that, although coverage may be sparse in the item domain, it is often dense enough in the attribute domain, since attributes of various items are usually a relatively static domain. The system further analyzes the item attributes to compute similarity between the items using collaborative filtering techniques and to present recommendations to users based on such computations.

In the following description, numerous details are set forth for purposes of explanation. However, one of ordinary skill in the art will realize that the invention may be practiced without the use of these specific details. In other instances, well-known structures and devices are shown in block diagram form in order not to obscure the description of the invention with unnecessary detail.

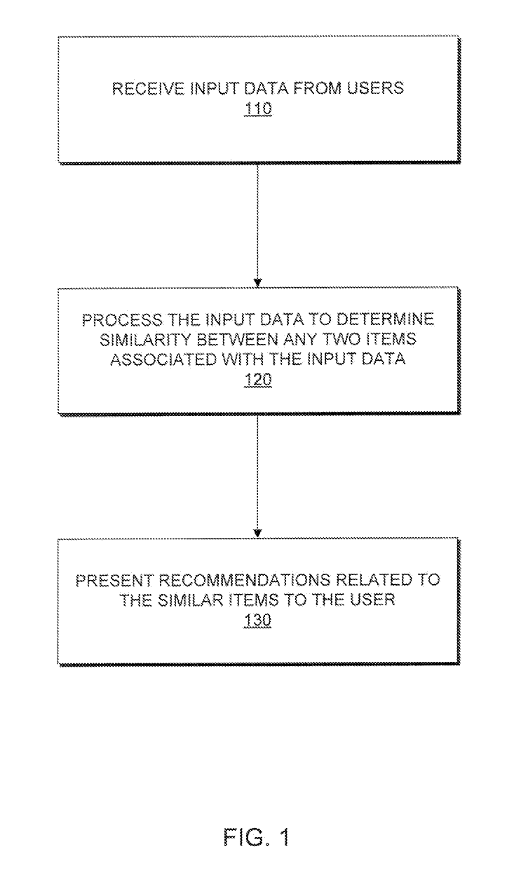

FIG. 1 is a flow diagram illustrating a processing sequence to determine similarity between items associated with input data received from users over a network and to facilitate recommendations of such similar items to users. As shown in FIG. 1, at processing block 110, the sequence starts with retrieval of input data from users. In one embodiment, the users connect to an entity, which contains a system to compute attribute-based similarity between items using collaborative filtering techniques, and input various data, as described in further detail below. The system receives the input data and stores the input data in corresponding data storage modules, as described in further detail below.

In one embodiment, input data includes multiple events performed within one or more user search and navigation sessions. A user search and navigation session encompasses activity that a user having a unique cookie performs in a predetermined period of time, which may or may not overlap with previous sessions associated with the same user. The events are then stored within one or more event logs to be used in subsequent processing within the entity.

In one embodiment, an event is a type of action initiated by the user, typically through a conventional mouse click command. Events include, for example, item purchase clicks, item clicks, page clicks, advertisement clicks, search queries, search clicks, sponsored listing clicks, page views, and advertisement views. However, events, as used herein, may include any type of online navigational interaction.

Next, at processing block 120, the input data is processed to determine similarity between items associated with the input data. In one embodiment, the system processes the input data to determine attributes of the items associated with the input data and to compute similarity parameters between attributes and items, respectively, as described in further detail below.

Finally, at processing block 130, recommendations related to similar items are transmitted to users. In one embodiment, the system determines similar items based on respective similarity parameters and further transmits recommendations containing the items to the specific users, as described in further detail below.

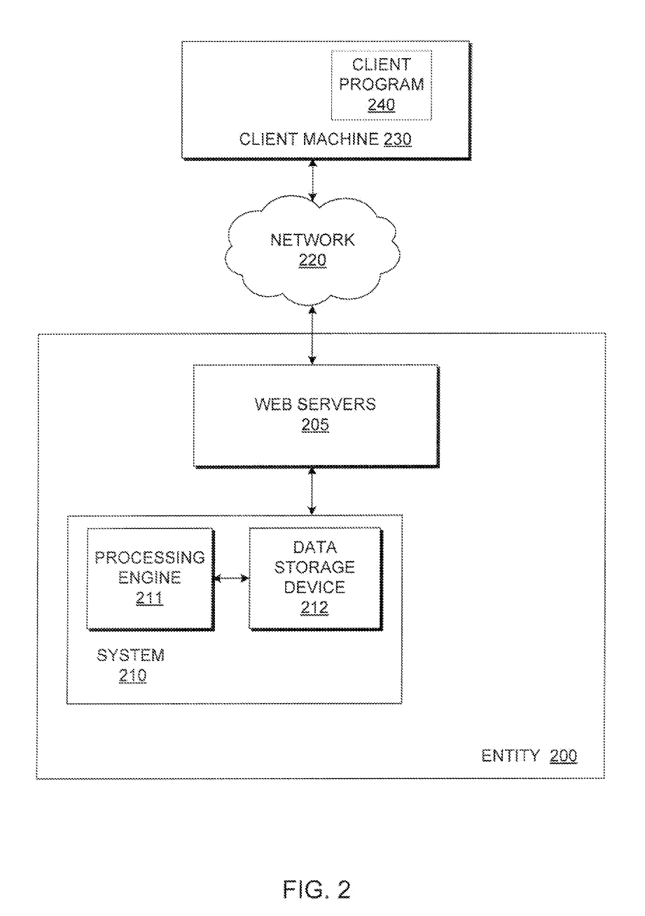

FIG. 2 is a block diagram illustrating an exemplary network-based entity containing a system to compute attribute-based similarity between items using collaborative filtering techniques. While an exemplary embodiment of the present invention is described within the context of an entity 200 enabling such computations, it will be appreciated by those skilled in the art that the invention will find application in many different types of computer-based, and network-based, entities.

In one embodiment, the entity 200, such as, for example, an Internet portal, includes one or more front-end web servers 205, which may, for example, deliver web pages to multiple users, (e.g., markup language documents), handle search requests or queries to the entity 200, provide automated communications to/from users of the entity 200, deliver images to be displayed within the web pages, deliver content information to the users, and other interface operations in connection with the users. Alternatively, the entity 200 may include a number of additional front-end servers (not shown), which provide an intelligent interface to the back-end of the entity 200.

In one embodiment, the entity 200 further includes one or more back-end servers coupled to the front-end web servers 205, such as, for example, various processing servers (not shown), and a system 210 to compute attribute-based similarity between items using collaborative filtering techniques, as described in further detail below, the system 210 being coupled to the front-end web servers 205 and any other back-end processing servers.

In one embodiment, the system 210 further includes a processing engine 211 coupled to a data storage device 212. The processing engine 211 may include software and/or hardware modules configured to perform retrieval, storage, and computation operations, as described in further detail below.

The data storage device 212, which at least partially implements and supports the system 210, may include one or more storage facilities, such as a database or collection of databases, which may be implemented as relational databases. Alternatively, the data storage device 212 may be implemented as a collection of objects in an object-oriented database, as a distributed database, or any other known databases. The data storage module 212 is accessible by the processing engine 211 and stores user data, event data, item data, and item metadata, as described in further detail below.

In one embodiment, users may access the entity 200 through a client program 240, such as a browser (e.g., the Internet Explorer browser distributed by Microsoft Corporation of Redmond, Wash.) that executes on a client machine 230 and accesses the facility 200 via a network 220, such as, for example, the Internet. Other examples of networks that a client may utilize to access the entity 200 includes a wide area network (WAN), a local area network (LAN), a wireless network (e.g., a cellular network), the Plain Old Telephone Service (POTS) network, or other known networks.

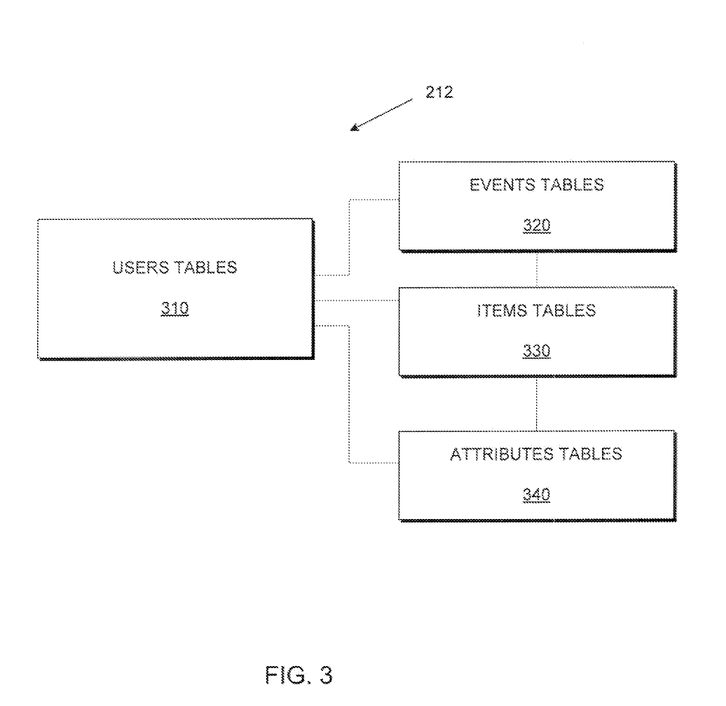

FIG. 3 is a block diagram illustrating an exemplary database, which at least partially implements and supports the network-based entity 200 and the system 210. In one embodiment, the database 212 shown in FIG. 3 may be implemented as one or more relational databases, and may include a number of tables having entries, or records, that are linked by indices and keys. Alternatively, the database 212 may be implemented as a collection of objects in an object-oriented database, as a distributed database, or any other known database.

As illustrated in FIG. 3, in one embodiment, the exemplary database 212 includes multiple tables, of which tables specifically provided to enable an exemplary embodiment of the invention, namely user tables 310, event tables 320, item tables 330, and attribute tables 340, are shown.

In one embodiment, the user tables 310 contain a record for each user of the entity 200, such as, for example, a user profile containing user data, which may be linked to multiple events, items and item attributes stored in the event fables 320, the item tables 330, and the attribute tables 340, respectively, such as, for example, user identification information, user account information, and other known data related to each user. The user identification information may further include a user profile containing demographic data about the user, geographic data detailing user access locations, behavioral data related to the user, such behavioral data being generated by a behavioral targeting system, which analyzes user activities in connection with the entity 200, and other identification information related to each specific user.

In one embodiment, the event tables 320 store various events, collected automatically or, in the alternative, manually, during user navigation sessions from various servers within the entity 200, from editors associated with the entity 200, and/or from other third-party entities connected to the entity 200 via the network 220.

In one embodiment, the item tables 330 store items related to the events input by the users, such as, for example, products and services viewed and/or purchased by users over the network 220. The attribute tables 340 store item metadata associated with each item stored within the item tables 330, such as, for example, attributes of such items and their respective values.

It is to be understood that the database 212 may include any of a number of additional tables, which may also be shown to be linked to the tables 310 through 340.

In one embodiment, considering a group of active users interested in items such as digital cameras who connect with the entity 200 via the network 220 to view and purchase digital cameras, each item having multiple attributes and corresponding values for each attribute, such as, for example, brand, resolution and zoom, input data may be illustrated as follows:
i1=Canon, 5.1 megapixel, 3× zoom
i2=Canon, 6.0 megapixel, 12× zoom
i3=Nikon, 5.0 megapixel, 4× zoom

where i1, i2, and i3 are the items stored within the item tables 330, Canon and Nikon are values for a categorical attribute of each item (Brand), the megapixel values represent values for a numerical attribute of each item (Resolution), and the zoom values represent values for a second numerical attribute of each item (Zoom), all stored within the attribute tables 340.

In one embodiment, each item i1, i2, and i3 is also linked to one or more users who purchased or viewed the respective item, having user data stored within the user tables 310 and to a corresponding event input by the users and stored within the event tables 320.

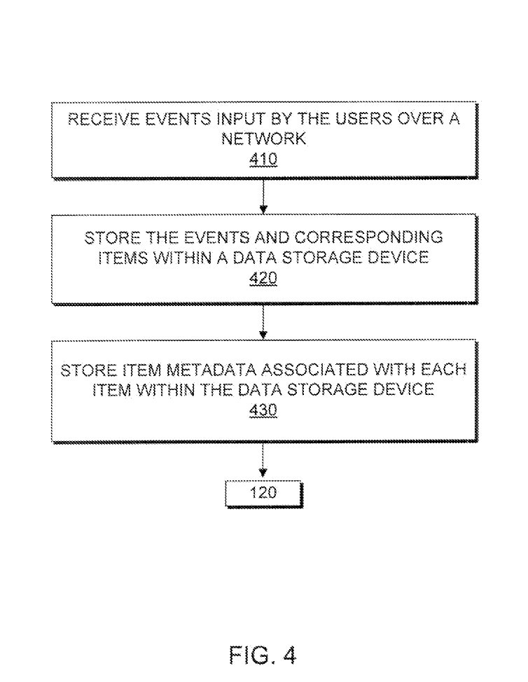

FIG. 4 is a flow diagram illustrating a method to receive and store input data over the network. As illustrated in FIG. 4, at processing block 410, events input by the users over the network 220 are received. In one embodiment, the web servers 205 receive multiple events input by the users over the network 220 and transmit the events to the system 210 within the entity 200. The processing engine 211 within the system 210 receives the event input data and stores the data in appropriate data storage modules within a data storage device 212, as described in further detail below.

At processing block 420, the events and corresponding items are stored in the data storage device 212. In one embodiment, the processing engine 211 stores event data within the event tables 320, and further stores one or more items corresponding to each event into the item tables 330.

At processing block 430, item metadata associated with each item is stored within the data storage device 212. In one embodiment, the processing engine 211 stores metadata associated with each item, such as, for example, attributes associated with each item and their corresponding values, into the attribute tables 340 within the data storage device 212. Next, the procedure jumps to processing block 120 shown in connection with FIG. 1.

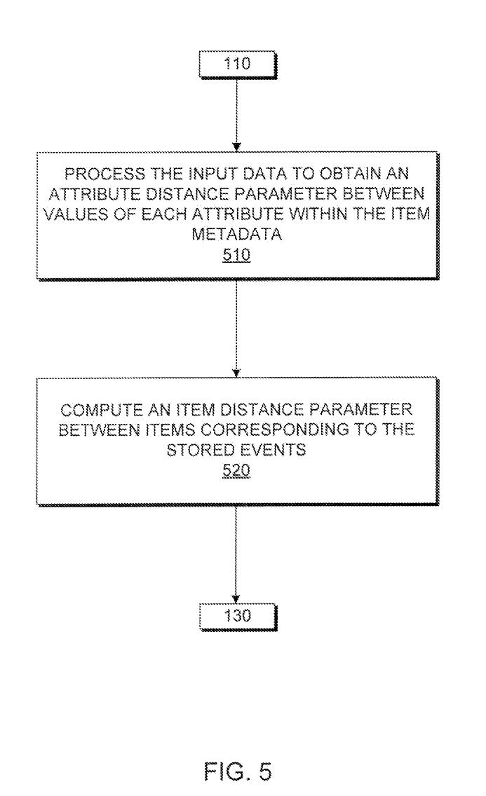

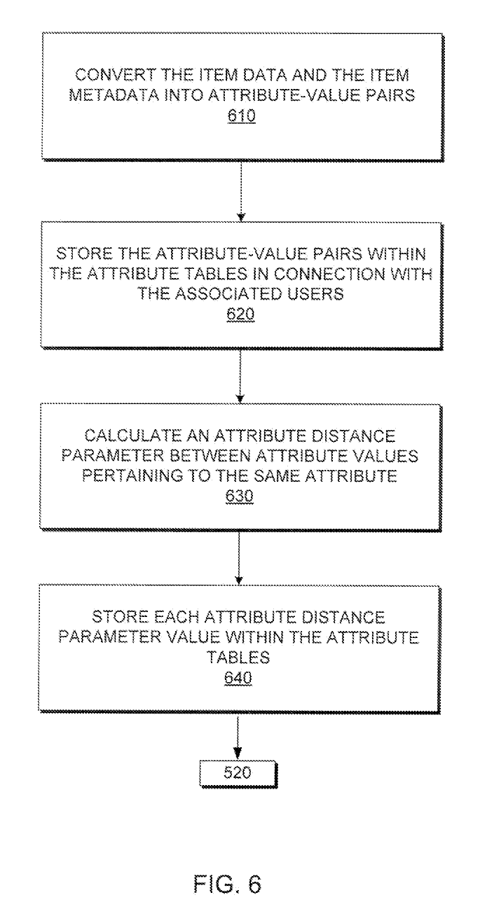

FIG. 5 is a flow diagram illustrating a method to process the input data within the system 210 to determine similarity between items associated with the input data. As shown in FIG. 5, the method starts with the receipt of input data shown at processing block 110 of FIG. 1. Next, at processing block 510, input data is further processed to obtain an attribute distance parameter between values of each attribute within the item metadata, as described in detail below in connection with FIG. 6. In one embodiment, the processing engine 211 processes the user data stored within the user tables 310, the item data stored within the item tables 330, and the item metadata stored within the attribute tables 340 to calculate an attribute distance parameter between attribute values pertaining to each attribute of art item.

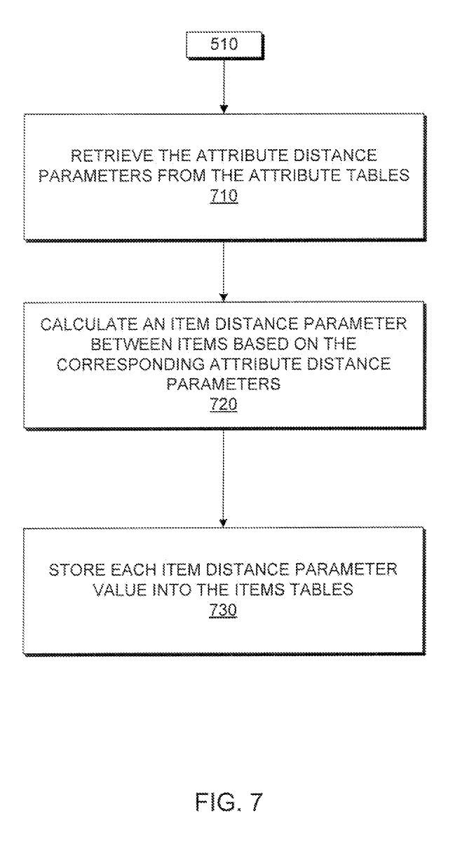

At processing block 520, an item distance parameter between any pair of items is further computed, as described in detail below in connection with FIG. 7. In one embodiment, the processing engine 211 uses the attribute distance parameters to calculate the item distance parameter between a pair of items in order to determine if the respective items are similar or not and the degree of similarity between items. Next, the procedure jumps to processing block 130 shown in connection with FIG. 1.

FIG. 6 is a flow diagram illustrating a method to compute attribute distance parameters within the system 210. As shown in FIG. 6, at processing block 610, the item data and the item metadata are converted into attribute-value pairs corresponding to each particular item.

In one embodiment, the processing engine 211 within the system 210 receives the item data and the item metadata, i.e. the attributes of each item and their corresponding values, and converts the data into various attribute-value pairs linked to the user data, i.e. the users who clicked/purchased/rated the specific items. Each attribute-value pair can be represented as a vector of users:

aX_{—}vX=w1.u 1+w2.u2+ . . . +wN.uN

where aX_vX is an exemplary attribute-value pair X, such as, for example, Brand_Canon, Resolution_{—}5.1, or Zoom_{—}3X, u1 through uN are the respective users, and w1 through wN are weight values, which can be defined by the intensity of the user interest in a particular item.

At processing block 620, the attribute-value pairs are stored within the attribute tables 340 in connection with the associated users stored within the user tables 310. In one embodiment, the processing engine 211 stores the attribute-value pairs within the attribute tables 340.

At processing block 630, an attribute distance parameter between attribute values pertaining to the same attribute associated with an item is calculated. In one embodiment, the processing engine 211 within the system 210 calculates each attribute distance parameter based on corresponding attribute-value pairs stored within the attribute tables 340, using a cosine dot product function of the user vectors for each attribute value as follows:

$$\begin{matrix}D ( a1\_v1 , a1\_v2 ) = \vert a1\_v1 \cdot a1\_v2 \vert \hat{} 2 / ( \vert a1\_v1 \vert \times \vert a1\_v2 \vert ) \\ = P ( a1\_v1 \& a1\_v2 ) \hat{} 2 / ( P ( a1\_v1 ) \times P ( a1\_v2 ) )\end{matrix}$$

where a1 is the attribute, v1 and v2 are the corresponding attribute values, D is the attribute distance parameter, and P(X) denotes the probability of users being interested in the attribute-value pair X.

In alternate embodiments, other distance metrics may be calculated without departing from the scope of the present invention, such as, for example, D(a1_v1, a1_v2)=P(a1_v1 &a1_v2)−(P(a1_v1)×P(a1_v2)).

At processing block 640, each attribute distance parameter is stored within the attribute tables 340. In one embodiment, the processing engine 211 stores the calculated attribute distance parameters within the attribute tables 340 of the data storage device 212. Alternatively, the attribute distance parameters may be stored into corresponding distance tables (not shown) linked to the attribute fables 340 within the data storage device 212. The procedure then jumps to processing block 520 shown in FIG. 5.

FIG. 7 is a flow diagram illustrating a method to compute item distance parameters between items associated with the input data based on corresponding attribute distance parameters. As shown in FIG. 7, the method starts with processing block 510 shown in FIG. 5. Next, at processing block 710, the attribute distance parameters are retrieved from the attribute tables 340. In one embodiment, the processing engine 211 retrieves the attribute distance parameters from the attribute tables 340 within the data storage device 212 or, in an alternate embodiment, from the distance tables (not shown) linked to the attribute tables 340.

At processing block 720, an item distance parameter between items is calculated based on the corresponding attribute distance parameters. In one embodiment, if each item is represented as a set of attribute-value pairs:

i1−(a1_{—}v1, a2_{—}y1, . . . ) and

i2−(a1_{—}v2, a2_{—}y2, . . . )

the item distance parameter between the items i1 and 12 may be calculated as follows:

D′(i1, i2)=D(a1_{—}v1, a1_{—}v2)+D(a2_{—}y1, a2_{—}y2)+ . . .

In alternate embodiments, other similar distance functions may be defined without departing from the scope and spirit of the present invention, such as, for example,

D′(i1, i2)=D(a1_{—}v1, a1_{—}v2)×D(a2_{—}y1, a2_{—}y2)× . . .

In one embodiment, the lower the value of the calculated item distance parameter, the closer and more similar the items are for purposes of recommendation or prediction.

Finally, at processing block 730, each item distance parameter is stored within the item tables 330. In one embodiment, the processing engine 211 stores the calculated item distance parameters within the item tables 330 of the data storage device 212. Alternatively, the item distance parameters may be stored into corresponding distance tables (not shown) linked to the item tables 330 and the attribute tables 340 within the data storage device 212.

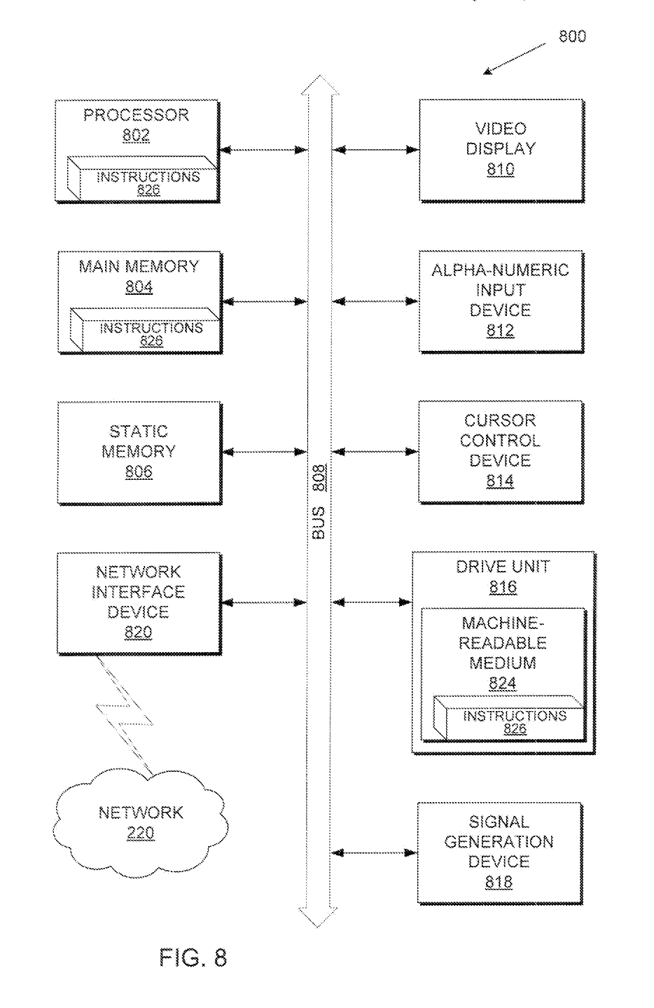

FIG. 8 shows a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
receiving events input by a user over a network, said events further comprising a plurality of items and associated item metadata; and
calculating a similarity value between each pair of items within said plurality of items based on corresponding attributes of each item stored within said item metadata.

2. The method according to claim 1, further comprising:
presenting recommendations of said items to said user based on said corresponding calculated similarity value.

3. The method according to claim 1, further comprising:
storing said events within a data storage device; and
storing said item metadata within said data storage device, said item metadata further comprising said corresponding attributes of said each item.

4. The method according to claim 1, wherein said calculating further comprises:
calculating an attribute distance parameter between attribute values pertaining to each attribute of said each item; and
calculating an item distance parameter between any pair of items of said plurality of items based on said respective attribute distance parameters to determine a degree of similarity between said items characterized by said similarity value.

5. The method according to claim 4, wherein calculating said attribute distance parameter further comprising:
converting said plurality of items and said associated item metadata into attribute-value pairs corresponding to said each item;
storing said attribute-value pairs within attribute fables of a data storage device in connection with said associated user; and
calculating said attribute distance parameter based on said stored attribute-value pairs using a cosine dot product function.

6. The method according to claim 5, wherein calculating said item distance parameter further comprising:
retrieving said respective attribute distance parameters from said attribute tables;
calculating said item distance parameter based on said retrieved attribute distance parameters; and
storing said item distance parameter within respective item tables of said data storage device.

7. A computer readable medium containing executable instructions, which, when executed in a processing system, cause said processing system to perform a method comprising:
receiving events input by a user over a network, said events further comprising a plurality of items and associated item metadata; and
calculating a similarity value between each pair of items within said plurality of items based on corresponding attributes of each item stored within said item metadata.

8. The computer readable medium according to claim 7, wherein said method further comprises:
presenting recommendations of said items to said user based on said corresponding calculated similarity value.

9. The computer readable medium according to claim 7, wherein said method further comprises:
storing said events within a data storage device; and
storing said item metadata within said data storage device, said item metadata further comprising said corresponding attributes of said each item.

10. The computer readable medium according to claim 7, wherein said calculating further comprises:
calculating an attribute distance parameter between attribute values pertaining to each attribute of said each item; and
calculating an item distance parameter between any pair of items of said plurality of items based on said respective attribute distance parameters to determine a degree of similarity between said items characterized by said similarity value.

11. The computer readable medium according to claim 10, wherein calculating said attribute distance parameter further comprising:
converting said plurality of items and said associated item metadata into attribute-value pairs corresponding to said each item;
storing said attribute-value pairs within attribute tables of a data storage device in connection with said associated user; and
calculating said attribute distance parameter based on said stored attribute-value pairs using a cosine dot product function.

12. The computer readable medium according to claim 11, wherein calculating said item distance parameter further comprising:
retrieving said respective attribute distance parameters from said attribute tables;
calculating said item distance parameter based on said retrieved attribute distance parameters; and
storing said item distance parameter within respective item tables of said data storage device.

13. A system comprising:
at least one web server to receive events input by a user over a network, said events further comprising a plurality of items and associated item metadata; and
a processing engine coupled to said at least one web server to compute a similarity value between each pair of items within said plurality of items based on corresponding attributes of each item stored within said item metadata.

14. The system according to claim 13, wherein said processing engine further presents recommendations of said items to said user based on said corresponding calculated similarity value.

15. The system according to claim 13, wherein said processing engine further stores said events within a data storage device and stores said item metadata within said data storage device, said item metadata further comprising said corresponding attributes of said each item.

16. The system according to claim 13, wherein said processing engine further calculates an attribute distance parameter between attribute values pertaining to each attribute of said each item, and calculates an item distance parameter between any pair of items of said plurality of items based on said respective attribute distance parameters to determine a degree of similarity between said items characterized by said similarity value.

17. The system according to claim 16, wherein said processing engine further converts said plurality of items and said associated item metadata into attribute-value pairs corresponding to said each item, stores said attribute-value pairs within attribute tables of a data storage device in connection with said associated user, and calculates said attribute distance parameter based on said stored attribute-value pairs using a cosine dot product function.

18. The system according to claim 17, wherein said processing engine further retrieves said respective attribute distance parameters from said attribute tables, calculates said item distance parameter based on said retrieved attribute distance parameters, and stores said item distance parameter within respective item tables of said data storage device.
